(19) United States
(12) Patent Application Publication
(10) Pub. No.: US 2009/0119021 A1
(43) Pub. Date: May 7, 2009

(54) METHOD AND APPARATUS FOR DETERMINING AND DISPLAYING MEDICAL INFORMATIONS

(76) Inventors: Regina Schuett, Jena (DE); Eberhard Hagen, Jena (DE); Michael Trost, Stadtroda (DE)

Correspondence Address: HOFFMAN WARNICK LLC, 75 STATE STREET, 14TH FLOOR, ALBANY, NY, 12207, US

(21) Appl. No.: 12/261,354

(22) Filed: Oct. 30, 2008

(30) Foreign Application Priority Data
Nov. 2, 2007 (DE) 10 2007 052 282.9

(51) Int. Cl. G06F 19/00

(52) U.S. Cl. 702/19

(57) ABSTRACT

The invention relates to a method for determining and displaying medical informations, in which rough measurement data collected with the aid of different medical measuring methods in at least one measurement interval on the same test subject are stored and in which evaluation data are extracted from the rough measurement data. Further for generating medical informations for at least two selected measuring methods from among the different medical methods, the evaluation data extracted from the in each case associated rough measurement data of a measurement interval are interlinked and for the at least one measurement interval the linked evaluation data are processed as medical informations for outputting on a graphic output device. The invention also relates to an apparatus for performing this method.

### BACKGROUND OF THE INVENTION

According to a first aspect, the invention relates to a method for determining and displaying medical informations.

In a second aspect, the invention relates to an apparatus for determining and displaying medical informations.

For analysis, e.g. of eye complaints, for a reliable determination of the disease it is often not adequate to use for evaluation purposes data and informations determined using only a single measurement method. It is therefore necessary to link and evaluate rough measurement data determined by different opthalmological measuring methods. For example, for the determination of a glaucoma it is not sufficient to merely determine the eye internal pressure. This is admittedly a sign of such a disease, but can vary significantly between individual test subjects.

It is therefore necessary to establish different data by means of further measuring methods. For glaucoma disease analysis, they can consist of a nerve fibre analysis by a GDx scan, a 30° papilla photo and a RNFL (Retina Nerve Fibre Layer) thickness analysis by an optical coherence tomograph.

The time change of the data in question is specifically of interest in analyzing a glaucoma disease. This means that normally the person carrying out the treatment must obtain single reports, so-called reports, from the different, often autonomous measuring equipments. In order to be able to additionally investigate the change in the values over a period of time, these reports were collected over several time-spaced measurements and then manually combined.

However, this procedure is extremely time and cost intensive. The individual measuring equipments frequently determine with different measuring methods, apart from the different types of measurement data, also coinciding informations which are not redundantly required for such an evaluation.

To avoid such problems, it is only possible to obtain a further combined measuring device, which can perform several different measuring methods, in order to permit a reliable detection of the disease. However, this is economically unfavourable, because already individual devices exist which can perform the same measuring methods.

The object of the invention is to provide a method and an apparatus for performing said method, with which it is possible to effectively combine data from different medical, in particular opthalmological, measuring methods.

### BRIEF SUMMARY OF THE INVENTION

In a first aspect this object is achieved by a method having the features of claim 1.

In a second aspect the object is achieved by an apparatus having the features of claim 16.

Further advantageous embodiments are given in the dependent claims, the description, the drawings and the explanations thereof.

According to the inventive method the rough measurement data are stored. Said rough measurement data were established by means of different medical, particularly ophthalmological measuring methods, during measurements on a test subject. From said different stored rough measurement data evaluation data are subsequently extracted. In order to generate medical, particularly opthalmological informations, evaluation data extracted from the rough measurement data of at least two selected, different medical measuring methods are linked with one another. Following on to this the linked evaluation data are processed for outputting as medical, particularly opthalmological information, so that they can be displayed on a graphic display unit.

It is a fundamental idea of the invention that results obtained from different measuring devices and/or the results of the same measuring device, are in particular centrally stored and at least partial results therefrom are selectively combined. Although the absolute quantity of data available for the detection or analysis of a disease is reduced, this still makes it possible to make available an improved starting base, because redundant data are extracted and additionally from the individual rough measurement data or measurement results not identifiably combined informations are determined and displayed. As less data and informations have to be processed, such a processing operation is faster and less costly, so that resources are protected.

In a preferred embodiment the rough measurement data are obtained in a plurality of time-spaced measurement intervals and consequently rough measurement data are available for several different measurement intervals. Then, for generating medical, particularly opthalmological informations, evaluation data of one measurement interval are interlinked. Following on to this the linked evaluation data for different measurement intervals are processed for outputting as medical, particularly opthalmological information.

Thus, e.g. for glaucoma evaluation, nerve fibre analysis, a 30° papilla photo and a HFA analysis are performed. These three measuring methods are carried out again on the same test subject at least in one time-spaced measurement interval. As a function of the assumed speed of the change, the time spacing between the individual measurement intervals can be between a few weeks and years. The measurement intervals, in which the different opthalmological measuring methods are in each case performed, should be short compared with the time spacing of the different measurements with the same measuring method. For example, a measurement interval of one to two weeks is appropriate if the next measurement interval has a six month spacing.

Evaluation data are then extracted from the rough measurement data determined in the different measuring methods. According to the present invention rough measurement data are both data which are generated in the measuring device directly following the first analog-digital conversion, but also processed data which already enable conclusions to be drawn. The precise data evaluated and extracted can be established as a function of the disease to be investigated. The different measuring methods available for generating the rough measurement data also play a part. It is possible here to multiply eliminate data determined redundantly by different measuring methods or also form a mean value of said data so as to bring about greater reliability for the evaluation data. Another option is to only further process parts of the rough measurement data determined by a medical, particularly opthalmological measuring method to give medical, particularly opthalmological informations. Thus, it is possible to carry out filtering between particularly important and data e.g. irrelevant for a first evaluation.

Then, for at least two selected measuring methods selected as a function of the disease to be investigated, it is provided that the evaluation data are interlinked so that, on the basis of the link, additional informations are available for disease evaluation. Basically it is appropriate to interlink evaluation data determined within the same measurement interval. As a function of the change to be evaluated, it can also be appropriate to interlink evaluation data of different measurement intervals emanating from different measuring methods.

In a subsequent processing for graphic display of the medical, particularly ophthalmological informations generated by the linking operation, e.g. in order to image a progression path, linked evaluation data determined by means of the same pair of measuring methods are displayed for different measurement intervals. This provides the additional information of how quantities have evolved over time. As a result of such a clearly arranged processing of the rough measurement data a rapid analysis can take place on the part of an observer.

In a preferred variant of the inventive method, evaluation data of a selected pair of different opthalmological measuring methods extracted from the associated rough measurement data of a measurement interval are mathematically, geometrically and/or spatially interlinked in order to generate a link parameter. This link parameter, which can also be referred to as link information, can be generated by mathematical linking by basic arithmetic operations, such as addition, subtraction, multiplication or division. The link is also possible by means of more complex, mathematical or statistical functions. Further possibilities for generating opthalmological informations are e.g. not only to use evaluation data for a specific time interval, but instead use for the link evaluation data from several different time intervals. It is also possible to subject to a correlation analysis or also an autocorrelation analysis different evaluation data determined by different measuring methods with respect to several different time intervals.

It is fundamentally possible to achieve the inventive advantages when taking account of evaluation data emanating from only a single selected pair of different opthalmological measuring methods. However, it is particularly advantageous to extract the evaluation data from rough measurement data from several, e.g. three or four opthalmological measuring methods and to interlink and display said evaluation data. Examples for evaluation data from different rough measurement data generated by opthalmological measuring methods are nerve fibre layer thickness, the visual field, the visual acuity, the sight and/or the macular thickness.

In a preferred development of the inventive method the linked evaluation data are processed in graph form. This provides a particularly clear representation of the change of the evaluation data or opthalmological informations over the different measurement intervals. X/Y graphs are e.g. suitable as graph-based displays. In such a display it is also possible to particularly easily graphically process and display the changes of two interlinked measurement data over a time period.

It has proved advantageous to extract in each case at least one scalar quantity as the evaluation datum from the rough measurement data at least for one selected pair of opthalmological measuring methods. This can e.g. be a quotient of two values reflecting the ratio. Once again a graphic representation can be used for displaying the time change of these scalar quantities.

Another preferred method for linking evaluation data is constituted by a spatial and/or geometrical link. Evaluation data can be processed to two or multi-dimensional charts. Another possibility consists of the evaluation data for the selected pair of ophthalmological measuring methods already existing in the form of two or multi-dimensional charts. In this case it is possible to link individual charts or details thereof in such a way that they can be displayed in juxtaposed or superimposed manner on the graphic output device. Thus, also individual opthalmological informations can be displayed as image series, which e.g. represent the course of a change. In a further variant informations of two charts are displayed in one another by means of at least one further dimension. For subsequent analysis by a human observer, two or multi-dimensional charts offer the advantage compared with scalar quantities that by means of a chart-like representation more information can be displayed more clearly for an observer than when using individual scalar data.

For a spatial link, e.g. the superimposing of evaluation data already present in chart form, the advantage is obtained of determining adjusting marks from the evaluation data and which can e.g. be blood vessels, the second cranial nerve and/or other characteristic changes or damage to the retina. These adjusting marks are detected on two charts to be interlinked. They can subsequently be used as a reference for the link, so that e.g. on superimposing said charts there is a precise orientation and/or scaling of the charts relative to one another. One superimposing possibility is e.g. in the case of a graphic display to provide the same in the form of a fading method, so that the user, e.g. by means of a slider control, can fade one chart into the other. It is also possible to provide the informations of one chart in another chart through additional informations, e.g. with false colours, brightness values or grey scale. Examples for such charts are the retina thickness over areas of the fundus image, retina scans or the visual field.

In a further inventive development of the method, besides the evaluation data from ophthalmological measuring methods, it is provided that further relevant data for test subjects are determined and used for generating opthalmological informations. These can e.g. be case history data, such as age, weight or size. In this connection account can also be taken of data determined by other measuring methods, e.g. the blood pressure or blood sugar. In order to be able to take account of such data in the determination and display method, it is firstly possible to separately input them by means of an input device to enable them to be stored. However, the data, preferably in the same way as the rough measurement data, are determined in time-spaced measurement intervals, stored and further processed in the method in the same way as said rough measurement data.

In a preferred embodiment of the method, the linked evaluation data are selected and linked as a function of the assumed disease. Thus, data unnecessary for evaluation are suppressed and consequently data processing is accelerated and also the conclusion drawn concerning the illness or disease is simplified, because data not to be taken into account are not displayed and can consequently not cause confusion. It is advantageous in this connection if the disease-specific compilation of the evaluation data can be fixed and stored by the person intended to evaluate the disease in such a way that said data compilation can be reused for extended determination and display processes.

Although in a first display opthalmological informations can be shown which are not based on the entire rough measurement data available, all the rough measurement data continue to be stored. Thus, it is possible at a later time to access other rough measurement data and additionally process the same to opthalmological informations, so that account can be taken of further informations and data not previously considered to be relevant.

Fundamentally any opthalmological measuring method is suitable for supplying the rough measurement data for the inventive method, provided that the data are electronically based. However, preference is given to measurement methods which are used for obtaining rough measurement data from fundus cameras, laser scanners, slit lamps, OCTs, perimeters, GDxs, IOL Masters, ultrasonic devices, wave front devices and/or corneal topography devices.

The graphic output of the medical, particularly opthalmological informations can be referred to as a report. In an advantageous embodiment said report, i.e. the precise compilation of the medical informations for the different measuring methods and/or measurement intervals, can be stored. This makes it possible to redisplay the report without repeated, complicated evaluation procedures. It is also advantageous if the selection of different medical measuring methods used for producing a report can also be stored and therefore used as a model for future reports. Said model can include further data, such as other informations not determined by measuring methods or the time intervals taken into account in the report.

Thus, with the described method it is e.g. possible to clearly display the time change of the nerve fibre layer thickness in addition to the progression representation of a visual field on the output device. The time change of the nerve fibre layer thickness can be imaged as a series of nerve fibre layer-false colour charts or as an X/Y graph of the nerve fibre layer thickness at a specific point over a time lapse. Another example is the display of the change to the macular thickness presented in the same X/Y graph with the change to the sight, besides an image series of fundus images. It is also possible to additionally display pathological changes, e.g. a lesion size, on a separate graph.

With the inventive method it is also possible to present numerical or quantitative results, e.g. represented by means of different coloured markings on fundus images, retina scans or the field of vision.

An inventive apparatus suitable for performing the inventive method has at least one memory unit, an extraction unit, a linking device and a graphic processing device. The memory unit is used for storing rough measurement data obtained with the aid of different opthalmological measuring methods in one or a plurality of time-spaced measurement intervals from the same test subject. The extraction device extracts evaluation data from said rough measurement data.

However, for implementing the inventive method it is not necessary to directly store rough measurement data in the memory unit. It is also possible to store different evaluation data instead of these or separately. This can e.g. be used for speeding up the evaluation process.

A linking device downstream of the memory unit and extraction device generates ophthalmological informations for at least one selected pair, i.e. at least two of the different opthalmological measuring methods. For this purpose the evaluation data associated with the different measuring methods and which have been extracted from the rough measurement data of one or more measurement intervals are interlinked. Subsequently for one or different measurement intervals the linked evaluation data are processed as opthalmological informations by a graphic processing device for outputting on a graphic output unit. Processing can e.g. consist of the producing of graphs, two or multi-dimensional charts or merely in the juxtaposed or superimposed display of ophthalmological informations.

In an advantageous embodiment the memory unit, the extraction device, the linking device and the graphic processing device are provided in a computing unit. However, it is not absolutely necessary to provide in one and the same computing unit all four of the aforementioned units or devices. For example, the memory unit can store the data at a random other location and merely provide access to the data. Thus, storage can e.g. take place in a data bank, which need not necessarily be in the computing unit. It can e.g. be a computer specifically set up as a data bank server. The function of the memory unit in this connection is to store and be able to poll again data, particularly rough measurement data, so that they can be further processed in the extraction device. Filing in the data bank can e.g. be organized on the basis of the name of the test subject.

It is fundamentally possible to perform the opthalmological measuring methods directly in an apparatus, which can firstly perform the different opthalmological measuring methods and secondly has the devices and means necessary for the downstream determination and display of the opthalmological informations. However, it is preferable if the opthalmological measuring methods are performed by separate measuring devices, e.g. a fundus camera, laser scanners, slit lamps, OCTs, perimeters, GDxs, IOL Masters, ultrasonic devices, wave front devices and/or corneal topography devices.

In an advantageous embodiment such separate measurement devices are connected by a data connection to the memory unit or computing unit. This data connection can e.g. be performed by means of information technology networks, e.g. IP-based network connections such as LAN or wireless LAN. Other possibilities are USB connections, serial or firewire connections. It is also possible when using separate measuring devices to delocalize the determination of the data, i.e. data collection. Thus, it is possible to carry out a first opthalmological measuring method at a first location and then perform a second opthalmological measuring method at another location. The rough measurement data generated in the methods are e.g. forwarded by an information technology network to the computing unit which stores and evaluates said data.

In order to be able to additionally store data, e.g. measurement data of a device for the measurement of the blood sugar level in the data bank, the computing unit preferably has corresponding interfaces, so that data can be transferred from external devices to the memory unit. It is also possible to provide a human/machine communication interface, e.g. in the form of an input device and an output device, so as to be able to supply the memory unit with further data, which can e.g. be the size, the weight and also the name of the test subject.

In a preferred embodiment it is possible to implement the method by means of a computer program product, which has computer code means for performing the method when the computer program is run on a computer. This can be a single work station, but also a computing unit or computing centre. This computer program product can also be stored on a data carrier. If the computer program is loaded into the working or main memory of the computing unit, it is then possible to perform the inventive method.

### BRIEF DESCRIPTION OF THE DRAWINGS

The invention is described hereinafter relative to an embodiment and the diagrammatic drawing, wherein shows:

FIG. 1A diagrammatic data flow chart of the inventive apparatus.

### DETAILED DESCRIPTION OF THE DRAWINGS

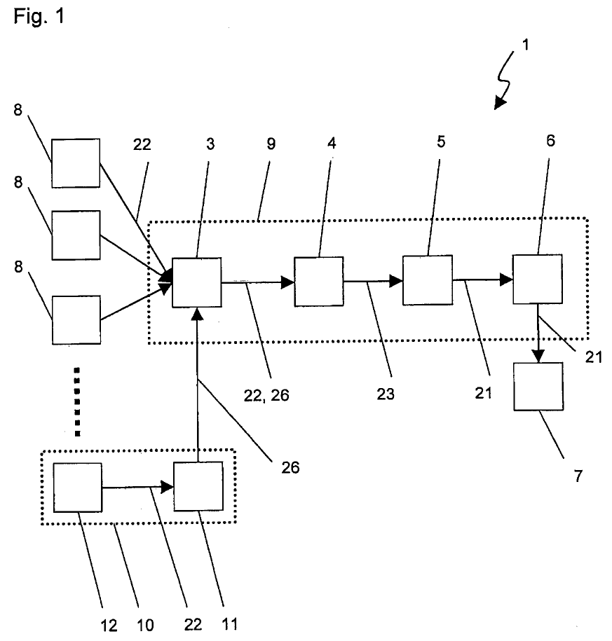

The fundamental structure of the inventive apparatus 1 and the elementary sequences of the inventive method will now be explained relative to FIG. 1.

Various measuring devices 8 and 10 are provided for performing the opthalmological measuring methods. Said measuring devices 8, 10 can e.g. be a fundus camera, a laser scanner, a slit lamp, an OCT, a perimeter, a GDx, an IOL Master, an ultrasonic device, a wave front device and/or a corneal topography device. The measuring devices 8, 10 are used for generating rough measurement data 22. As shown for the measuring device 8, the rough measurement data can be directly transferred via a data connection to the memory unit 3, where storage takes place. It is also possible for the rough measurement data 22 to be generated by a sensor 12 in the measuring device 10 and then processed within the measuring device 10 by a preprocessing unit 11, accompanied by partial evaluation.

It is e.g. possible here in the case of a separate measuring device 10, to provide outputting devices for outputting preprocessed or processed rough measurement data 26. However, for the inventive method at least the processed rough measurement data 26 are also transferred to the memory unit 3 for storage purposes. The memory unit 3 is located within a computing unit 9. The connection between the measuring devices 8, 10 and the memory unit 3 or computing unit 9 can e.g. be provided by a data connection of an IP-based network.

Subsequently the rough measurement data 22 stored by the computing unit 3 and the processed rough measurement data 26 are transferred to an extraction device 4, where parts of the rough measurement data 22, 26 are extracted, in order to e.g. eliminate existing redundancies or only select specific rough measurement data. A first preparation for linking the evaluation data 23 can take place here.

The evaluation data 23 are then transferred to the linking device 5, where there is a context-specific linking of individual evaluation data 23. Thus, interlinking takes place in the linking device 5 of evaluation data 23 selected as a function of the disease under investigation and determined in the same time interval by different measuring devices 8, 10. It is possible to generate link parameters as informative characteristics, which is particularly appropriate in the case of scalar or vector-based evaluation data 23. If the evaluation data 23 are in the form of two or multi-dimensional matrices, the individual elements can either be linked in accordance with the already described link parameters or also the informations of the individual matrices can be linked to multi-dimensional displays. A link parameter can e.g. be produced by a mathematical link and is e.g. a quotient.

Subsequently the opthalmological informations 21 generated in the linking device 5 are transferred to a processing device 6. Here the individual opthalmological informations are processed and combined e.g. to graphs, which represent the time lapse, i.e. the progression of individual evaluation data 23 or opthalmological informations 21, so as to be subsequently transferred to an output device 7, such as a printer or screen. The possibility exists at said output device 7 to particularly clearly display the thus processed and determined opthalmological informations 21.

Thus, the inventive method makes it possible through the effective combination of different rough measurement data to suppress non-relevant informations and allow a faster, more fluent evaluation of a disease or illness. In addition, the method more effectively utilizes existing resources.

1. Method for determining and displaying medical informations
in which rough measurement data collected with the aid of different medical measuring methods in at least one measurement interval on the same test subject are stored,
in which evaluation data are extracted from the rough measurement data,
in which for the generation of medical informations for at least two selected measuring methods from the various medical measuring methods, the evaluation data extracted from the in each case associated rough measurement data of the at least one measurement interval are interlinked and
in which for the at least one measurement interval the linked evaluation data are processed as medical informations for outputting on a graphic output device.

2. Method for determining and displaying medical informations according to claim 1, wherein
the rough measurement data are collected in a plurality of time-spaced measurement intervals,
for the generation of medical informations for at least two selected measurement methods, the evaluation data extracted from the in each case associated rough measurement data of a measurement interval are interlinked and
for different measurement intervals, the linked evaluation data are processed as medical informations for outputting on a graphic output device.

3. Method for determining and displaying medical informations according to claim 1, wherein
the medical measuring methods are opthalmological measuring methods and that opthalmological informations are determined and displayed.

4. Method for determining and displaying medical informations according to claim 1, wherein
for forming at least one link parameter evaluation data of a selected pair of the different medical measuring methods extracted from the in each case associated rough measurement data of a measurement interval are interlinked by at least one of the group consisting of a mathematical, a geometrical and a spatial link and
link parameters determined for different measurement intervals are processed as medical informations for outputting on a graphic output device.

5. Method for determining and displaying medical informations according to claim 1, wherein
the evaluation data are mathematically interlinked by basic arithmetic operations.

6. Method for determining and displaying medical informations according to claim 1, wherein
evaluation data of several medical measuring methods are interlinked and displayed.

7. Method for determining and displaying medical informations according to claim 1, wherein
evaluation data for at least one of the group consisting of nerve fibre layer thickness, field of vision, visual acuity, sight and macular thickness are extracted from the rough measurement data.

8. Method for determining and displaying medical informations according to claim 1, wherein
the linked evaluation data are processed as a graph.

9. Method for determining and displaying medical informations according to claim 1, wherein
in each case at least one scalar quantity is extracted as the evaluation datum from the rough measurement data for the selected pair of medical measuring methods and
value pairs of said scalar quantity belonging to the given measurement intervals are displayed in a graph.

10. Method for determining and displaying medical informations according to claim 1, wherein
two or multi-dimensional charts are processed for the spatial linking of evaluation data.

11. Method for determining and displaying medical informations according to claim 1, wherein
the evaluation data for the selected pair of medical measuring methods are two or multi-dimensional charts and
the charts or details from the graphic output device are displayed in juxtaposed form.

12. Method for determining and displaying medical informations according to claim 1, wherein
the evaluation data for the selected pair of medical measuring methods are two or multi-dimensional charts and
the charts or details from the graphic output device are displayed in superimposed form.

13. Method for determining and displaying medical informations according to claim 1, wherein
for the spatial linking of evaluation data determination takes place of adjusting marks and
the adjusting marks are used as a reference for linking purposes.

14. Method for determining and displaying medical informations according to claim 13,
wherein
as adjusting marks at least one of the group consisting of blood vessels, the second cranial nerve and characteristic damage to the retina is used.

15. Method for determining and displaying medical informations according to claim 1, wherein
further data relevant for the test subject are taken into account for generating medical informations.

16. Method for determining and displaying medical informations according to claim 15,
wherein
as further data at least one of the group consisting of blood pressure, blood sugar and age are taken into account.

17. Method for determining and displaying medical informations according to claim 1, wherein
the evaluation data to be linked are selected in disease-specific manner.

18. Method for determining and displaying medical informations according to claim 1, wherein
the measuring methods for collecting rough measurement data are performed by at least one of the group consisting of fundus cameras, laser scanners, slit lamps, OCTs, perimeters, GDxs, IOL Masters, ultrasonic devices, wave front devices and corneal topography devices.

19. Apparatus for determining and displaying medical informations having
a memory unit for storing rough measurement data collected with the aid of different medical measuring methods in at least one measurement interval on the same test subject,
at least one extraction device which extracts evaluation data from the rough measurement data,
a linking device for generating medical informations for at least two selected measuring methods from among the different medical measuring methods, which interlinks the evaluation data extracted from the in each case associated rough measurement data of the at least one measurement interval and
a graphic processing device, which processes for at least one measurement interval the linked evaluation data as medical informations for outputting on a graphic output device.

20. Apparatus for determining and displaying medical informations according to claim 19,
wherein
the memory unit is designed for storing rough measurement data collected in a plurality of time-spaced measurement intervals from the same test subject,
the linking unit for generating medical informations for at least two selected measuring methods from among the different medical measuring methods interlinks the evaluation data extracted from the in each case associated rough measurement data of a measurement interval and
the graphic processing device processes the linked evaluation data for the different measurement intervals as medical informations for outputting on a graphic output device.

21. Apparatus for determining and displaying medical informations according to claim 20,
wherein
the memory unit, the extraction device, the linking device and the graphic processing device are provided in a computing unit.

22. Apparatus for determining and displaying medical informations according to claim 19,
wherein
for performing the different medical measuring methods at least one of measuring device of the group consisting of fundus cameras, laser scanners, slit lamps, OCTs, perimeters, GDxs, IOS Masters, ultrasonic devices, wave front devices and corneal topography devices is provided.

23. Apparatus for determining and displaying medical informations according to claim 19,
wherein
the separate measuring devices can be connected by at least one of the connecting means of the group consisting of IP-based network connections, USB, serial, wireless-LAN and firewire to the computing unit.

24. Computer program product with computer code means for performing the method according to one of the claims 1 to 18, when the computer program is run on a computer.

25. Data carrier, on which a computer program is stored, which performs the method according to one of the claims 1 to 18 following loading into a working and/or main memory.
